(19) United States
(12) Patent Application Publication
(10) Pub. No.: US 2026/0199817 A1
(43) Pub. Date: Jul. 16, 2026

(54) A VESSEL FOR A GAS TREATMENT UNIT AND ASSOCIATED METHOD

(71) Applicant: ATLAS COPCO AIRPOWER, NAAMLOZE VENNOOTSCHAP, Wilrijk (BE)

(72) Inventors: Tushar BHATT, Wilrijk (BE); Tom COREMANS, Wilrijk (BE); Frank VAN PUYENBROECK, Wilrijk (BE)

(73) Assignee: ATLAS COPCO AIRPOWER, NAAMLOZE VENNOOTSCHAP, Wilrijk (BE)

(21) Appl. No.: 19/136,234

(22) PCT Filed: Dec. 12, 2023
(86) PCT No.: PCT/IB2023/062548

§ 371 Date: Jun. 5, 2025

(30) Foreign Application Priority Data
Jan. 5, 2023 (BE) BE20235003

(51) Int. Cl. B01D 53/04; B01D 53/88

(52) U.S. Cl. CPC B01D 53/0423; B01D 53/885

(57) ABSTRACT

A vessel for an adsorber, including at least a first aperture configured to receive and to release gas and at least a second aperture configured to release and to receive gas, the first and the second apertures defining a passage between them; an adsorbent material or catalyst placed between the first and the second apertures, the adsorbent material or catalyst being configured to adsorb or trap at least partially at least one component of gas received by the adsorbent material or catalyst; at least a flexible compressible element arranged in the passage configured to fix the adsorbent material or catalyst in the passage, the flexible compressible element having a higher compressibility than the adsorbent material or catalyst.

### FIELD OF THE INVENTION

The field of the invention relates to a vessel for an air or gas treatment unit. It also relates to a method for using such a vessel.

### DESCRIPTION OF RELATED ART

In a known vessel of an air or gas treatment unit the adsorbent material is for example in the form of beads. Gas passes through the vessel at a high velocity. One potential problem in such a vessel is the fluidization of beads where the beads no longer remain stationary in the vessel. This may cause attrition of beads which is undesirable.

### SUMMARY OF THE INVENTION

Some embodiments of the present disclosure relate to a vessel which can fix the adsorbent material with reduced risk of fluidization and of causing attrition (of the adsorbent material). In some embodiments of the present disclosure the adsorbent material is fixed in an oxygen generator with reduced fire hazard. Some embodiments of the present disclosure relate to a vessel which can avoid the adsorbent material from escaping the vessel.

According to the first aspect of the disclosure there is disclosed a vessel for an adsorber or reactor, comprising at least a first aperture configured to receive and to release gas and at least a second aperture configured to release and to receive gas, the first and the second apertures defining a passage between them. The vessel also comprises an adsorbent material or catalyst placed between the first and the second apertures, and at least a flexible compressible element arranged in said passage configured to fix the adsorbent material or catalyst in said passage. The adsorbent material or catalyst is configured to adsorb or trap at least partially at least one component of gas received by the adsorbent material or catalyst such that gas released from the adsorbent material or catalyst has an outgoing composition different from an incoming composition of the gas received by the adsorbent material or catalyst. The compressible element has a higher compressibility than the adsorbent material or catalyst.

Thanks to the flexible compressible element the adsorbent material or catalyst is fixed in the passage of the vessel. When the vessel is in use the chance that some of the adsorbent material or catalyst might vibrate is reduced. This in turn reduces the risk of attrition of the adsorbent material and consequently increases its lifespan.

In addition, by fixing the adsorbent material or catalyst in the passage, the risk that some of the adsorbent material or catalyst escapes the vessel through one outlet is also reduced. The quality of treated gas released from the outlet is therefore improved.

According to some embodiments of the present disclosure the vessel may have one or more of the following features, taken individually or according to any technically possible combinations:

The flexible compressible element is porous and is arranged between the adsorbent material or catalyst and the second aperture and/or between the adsorbent material or catalyst and the first aperture.

The porosity of the compressible element allows gas to pass through it. A porous compressible element can therefore be placed between the adsorbent material or catalyst and the aperture(s).

At least one of the flexible compressible element is able to be reduced by at least 25% in volume, preferably by at least 35% in volume, more preferably by at least 50% in volume, even more preferably by at least 85% in volume under a pressure of 0.01 MPa-2 MPa.

The excellent compressibility of the compressible element allows it to act like a cushion. It can reduce the risk of crushing and attrition of the adsorbent material or catalyst. The gas moving through the vessel moves the adsorbent beads. These adsorbent beads rub against the metallic vessel walls, in some cases the adsorbent beads rub against each other in the vessel. This will cause attrition of beads. Such risk is reduced by fixing the adsorbent bed and placing the compressible element between the beads and metallic plate in the vessel.

At least one of the flexible compressible elements has a porosity greater than 80%, preferably greater than 95% in an uncompressed state.

The high porosity allows gas to pass through the porous compressible element with little pressure drop. The energy loss caused by the compressible element is therefore minimised.

At least one of the flexible compressible elements has a porosity between 23% and 70% when its volume is reduced by 85% compared to an uncompressed state.

The compressible element retains certain porosity even when its volume has been greatly reduced. This means that even when the porous compressible element has been reduced in volume and become much more compact, the energy loss caused by it when gas passes through the porous compressible element is still low.

At least one of the flexible compressible elements occupies an entire cross section of the passage such that gas passes through the compressible element.

Under this possibility any gas that is to be released by the outlet passes necessarily through the compressible element. If gas brings any adsorbent material or catalyst with it the latter will necessarily have to pass through the porous compressible element. With at least some of the adsorbent material or catalyst being retained by the filtering property of the porous compressible element, the quality of gas treated by the vessel is improved. The chances that the air or gas treatment unit fails due to dusting of the adsorbent material or catalyst is also reduced.

At least one of the flexible compressible elements has a melting temperature higher than 250° C., preferably higher than 300° C., more preferably higher than 320° C.

By having high resistance to thermal stress, the compressible element can have wider applications. In particular, with this high melting temperature it is possible to use the compressible element in an oxygen generator without worrying about the fire hazard even if the temperature inside the oxygen generator is high, for example, as high as 60° C.

The flexible compressible element is configured to form a barrier between the adsorbent material or catalyst and the first aperture and/or between the adsorbent material or catalyst and the second aperture so as to prevent the adsorbent material or catalyst from escaping the vessel.

At least one of the flexible compressible element(s) is made of a knitted material, a non-woven material, a woven material, or a foam.

At least one of the flexible compressible element(s) forms a pad or a cushion.

This form of the compressible element provides a particularly good buffering for the adsorbent material or catalyst. The shock absorbing property of the compressible element is accordingly particularly satisfactory.

The adsorbent material or catalyst comprises a first portion and a second portion, the vessel further comprising an intermediate layer of the flexible compressible material sandwiched between the first portion and the second portion of the adsorbent material or catalyst.

The first portion of the adsorbent material or catalyst may have a different adsorbing property from that of the second portion of the adsorbent material or catalyst. By having two portions of adsorbent material or catalyst in the vessel, the vessel may have additional adsorbing properties not possible with only one type of adsorbent material or catalyst. The intermediate layer of the compressible material can for example prevent the first portion of the adsorbent material or catalyst from crushing the second portion of the adsorbent material or catalyst if the first portion and the second portion have different physical properties such as hardness.

The intermediate layer of the flexible compressible material is configured to reduce the mixing of the first portion with the second portion of the adsorbent material or catalyst.

The first portion of the adsorbent material or catalyst can therefore perform their adsorbing function independently from the second portion. This is preferable for example if a gaseous component can degrade significantly the adsorbing ability of the second portion and must be reduced by the first portion before gas goes through the second portion. According to some embodiments the first portion is configured to adsorb moisture and/or carbon dioxide, and the second portion is configured to adsorb nitrogen. The intermediate layer of the compressible material is for example configured to reduce the mixing of the first portion with the second portion of the adsorbent material or catalyst if the first portion and the second portion have different physical properties such as the adsorbent bead size.

The passage is a vertical passage, preferably a substantially cylindrical passage.

The vessel further comprises at least a plate configured for pressing the compressible element against the adsorbent material or catalyst, the plate being preferably perforated.

The plate improves the fixing of the adsorbent material or catalyst by exerting a force over the adsorbent material. For example, when the velocity of gas inside the vessel is high and the force it exerts on the adsorbent material or catalyst is great, the counter force from the plate ensures that the compressible element can resist potential movements of the adsorbent material or catalyst. According to some embodiments the plate helps distribute the force evenly over the cross-section of the adsorbent bed and/or keep the compressible element flat over the entire cross-section of the adsorbent bed.

The vessel further comprises one or more compression elements, such as one or more springs, the plate being located between the compression element(s) and the compressible element such that the compression element pushes the plate towards the compressible element.

The compression element applies a force on the plate. The compressible element can therefore resist an even higher pressure due to the movements of the adsorbent material or catalyst. In addition, with the plate between the compressible element and the compression element the pressure from the compression element can be spread across the surface of the compressible element, leading to a more uniform pressure distribution on the compressible element. According to some embodiments the force applied on the plate by the compression element(s) is strictly greater than the weight of the plate.

The plate and the vessel define at least a gap between them, the compressible element being configured to fill the gap so as to prevent the adsorbent material or catalyst from escaping the vessel.

This may also prevent the plate rubbing against the metallic vessel walls which may generate sparks.

The passage has a diameter between 49 mm and 3000 mm.

The vessel comprises a first mesh in the first aperture, and/or a second mesh in the second aperture.

By having a mesh at the inlet and/or at the outlet, any adsorbent material or catalyst having a diameter bigger than the mesh size of the first mesh and/or the second mesh can be prevented from leaving the vessel. Further damages caused by the adsorbent material or catalyst escaping to the outside of the vessel can be reduced.

The flexibility and/or the compressibility of the compressible element is capable of reducing the crushing of the adsorbent material or catalyst.

The matrix of the porous flexible compressible element is capable of enhancing the distribution of gas passing through it over the cross section of the passage.

The vessel further comprises an additional compressible element between the adsorbent material or catalyst and the first aperture, and/or between the adsorbent material or catalyst and the second aperture.

With an additional compressible element between the adsorbent material or catalyst and the first aperture and/or the second aperture, the adsorbent material or catalyst can be prevented from leaving the vessel since any adsorbent material or catalyst leaving the vessel has to pass necessarily through either the compressible element or the additional compressible element. For example, in the embodiment where the additional compressible element is placed between the adsorbent material or catalyst and the second aperture, the additional compressible element is placed between the adsorbent material or catalyst and the first aperture and compliments the compressible element which is placed between the adsorbent material or catalyst and the second aperture. Therefore, any adsorbent material or catalyst that is to leave the vessel must pass necessarily through either the compressible element or the additional compressible element. No adsorbent material or catalyst can leave the vessel without passing either through the compressible element or the additional compressible element. The possibility that the adsorbent material or catalyst leaves the vessel is further reduced.

A pressure drop across the flexible compressible element is lower than 6 mbar absolute.

This feature ensures that the energy loss caused by the compressible element is low.

The compressible element is arranged and configured such that the adsorbent material or catalyst remains substantially immobilised when gas passes through it.

By substantially immobilising the adsorbent material or catalyst the problem of attrition of the adsorbent material or catalyst is practically eliminated. In addition, substantially no adsorbent material or catalyst will escape via the outlet(s).

At least one of the flexible compressible element(s) is impermeable.

The impermeable compressible element(s) can be used in addition to or as an alternative to the porous compressible element as described above. An impermeable compressible element does not allow any gas to pass through it. It also improves the fixing of the adsorbent material or catalyst by the plate.

At least one of the first aperture and the second aperture is sealed from an upper wall of the vessel to the top level of the adsorbent material or catalyst.

The compressible element is incombustible in a 60° C. environment having 95% oxygen and a pressure of 10 bar absolute.

The excellent incombustibility of the compressible element makes it suitable for oxygen-rich environments, such as inside oxygen generators.

The compressible element is made of a material inert to an incoming gas received from the at least a first aperture or from the at least a second aperture, and/or an outgoing gas released from the at least a second aperture or from the at least a first aperture, and/or a material inert to the material of the vessel, and/or a material inert to the adsorbent material or catalyst, and/or a material inert to the material of the plate, and/or a material inert to the material of the compression element(s).

By having an inert material, the compressible element would not change the composition of gas that passes through it. Also, the chemical composition of the compressible element will not be changed by gas passing through it, which extends the operational lifespan of the compressible element. In addition or as an alternative, the compressible element does not react with the vessel and/or the adsorbent material or catalyst and/or the plate, thereby extending their lifespan.

The flexible compressible element is essentially made of perfluoroalkoxy alkane, or polytetrafluoroethylene, or fluorinated ethylene propylene.

These materials have a high melting temperature and/or ignition temperature which make them particularly suitable for use in oxygen generators.

The adsorbent material or catalyst is configured to adsorb at least one type of gas chosen from the list of: carbon dioxide and/or moisture and/or nitrogen and/or oxygen and/or argon and/or hydrogen and/or hydrogen sulphide and/or mercaptans and/or paraffins, and/or acid gases, and/or silanes, and/or mercury vapour, and/or hydrocarbons, and/or trace contaminants in air or gas (sulphur dioxide, hydrogen chloride, nitrous oxide, ozone, hydrocarbons, volatile organic compounds, NOx, dust, radioactive rare gases, ammonia).

The adsorbent material or catalyst includes metal-organic frameworks, and/or carbon materials (such as activated carbon, carbon molecular sieves, carbon fibres), and/or resins, and/or polymers, and/or clays, and/or silica gel, and/or activated alumina, and/or natural or synthetic zeolites (types A, X, Y, mordenite, silicalite, chabazite, faujasite, clinoptilolite, and/or their ion-exchanged varieties: KA, 3A, 4A, 5A, 10A, Si-CHA, ITQ, ZSM, 13X, LiX, CaX, CA-LSX, Li-LSX, NaX, CaA).

The adsorbent material or catalyst is in the form of beads, pellets or specific structures like foams, fabric, monoliths, or laminates.

The present disclosure also relates to an air or gas treatment unit, preferably an oxygen or a nitrogen generator, or an air or gas dryer, or a desulfurization unit, or a solvent vapour recovery unit, or a silanes removal unit, or a trace radioactive rare gases removal unit, or a mercury vapour trapping unit, or a deodorizing and air freshening unit, or a trace ammonia removal unit, or a hydrogen production unit, or a gas separator, or an alcohol dehydrator, or a gas chromatograph, or a carbon dioxide and/or hydrogen sulphide and/or methane and/or ethane removal unit configured to remove at least parts of components from gas received from the at least a first aperture and/or from the at least a second aperture, comprising at least one vessel as described above, the vessel being configured preferably to receive compressed gas having a pressure between 1.1 bar absolute and 30 bar absolute.

According to the second aspect of the disclosure there is disclosed a method for using a vessel as described above, comprising the steps of:
receiving gas from the at least a first aperture (or, respectively, from the at least a second aperture),
the adsorbent material or catalyst adsorbing or trapping at least partially at least one component of gas received by the adsorbent material or catalyst, whilst the flexible compressible element(s) presses against the adsorbent material or catalyst,
releasing gas from the at least a second aperture (or, respectively, from the at least a first aperture).

Released gas from the adsorbent material or catalyst has an outgoing composition different from an incoming composition of the gas received by the adsorbent material or catalyst.

According to some embodiments of the present disclosure the method can have one or more of the following features, taken individually or according to any technically possible combinations:

Gas passes through the flexible compressible element.

The adsorbent material or catalyst remains substantially immobilised when gas passes through it.

Gas received by the at least a first aperture or the at least a second aperture and/or gas released from the at least a second aperture or the at least a first aperture has a flux between 0.1 Nm3/h and 16000 Nm3/h.

### BRIEF DESCRIPTION OF THE DRAWINGS

The above and further aspects of the disclosure will be explained in more detail below on the basis of a number of embodiments, which will be described with reference to the appended drawings. In the drawings:

FIG. 1 shows an embodiment of the present disclosure, the vessel comprising the adsorbent material, the compressible element, and two meshes in the two apertures. The compressible element is located between the adsorbent material and the second aperture which acts as the outlet of the vessel when gas flows in the axial direction of the vessel from the first aperture to the second aperture;

FIG. 2 shows an embodiment of the present disclosure, the vessel comprising, in addition to the components in FIG. 1, a perforated plate above the compressible element;

FIG. 3 shows an embodiment of the present disclosure, the vessel comprising, in addition to the components in FIG. 2, four compression elements between the plate and the second aperture;

FIG. 4 shows an embodiment of the present disclosure, the vessel comprising, in addition to the components in FIG. 3, a porous compressible element located between two portions of the adsorbent material;

FIG. 5 shows an embodiment of the present disclosure, the vessel comprising, in addition to the components in FIG. 4, an additional compressible element between the first aperture (which acts as the inlet of the vessel when gas flows in the axial direction of the vessel from the first aperture to the second aperture) and the adsorbent material;

FIG. 6 shows an embodiment of the present disclosure where gas flows in the radial direction of the vessel from the first aperture to the second aperture, the vessel comprising adsorbent material, the impermeable flexible compressible elements placed above adsorbent material, the porous compressible elements placed in at least one aperture and/or sandwiched between two portions of the adsorbent material;

FIG. 7 shows an embodiment of the present disclosure where, in addition to the components in FIG. 6, the vessel comprising a seal in the first and second apertures from the upper wall of the vessel until the top of the adsorbent material;

FIG. 8 shows an embodiment of the present disclosure where, in addition to the components in FIG. 7, the vessel comprising a solid plate on the impermeable compressible element;

FIG. 9 shows an embodiment of the present disclosure where, in addition to the components in FIG. 8, further comprising eight compression elements between the upper wall of the vessel and the plates.

### DESCRIPTION OF THE INVENTION

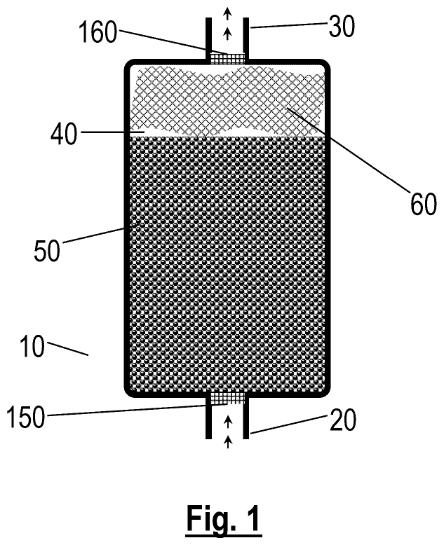

FIG. 1 shows a vessel 10 according to one embodiment of the present disclosure. The vessel 10 is for example for a gas adsorber or gas reactor, or an air or gas treatment unit. The gas treatment unit is for example an oxygen or a nitrogen or hydrogen generator, or an air or gas dryer, or a desulfurization unit, or a solvent vapour recovery unit, or a silanes removal unit, or a trace radioactive rare gases removal unit, or a mercury vapour trapping unit, or a deodorizing and air freshening unit, or a trace ammonia removal unit, or a hydrogen production unit, or a gas separator, or an alcohol dehydrator, or a gas chromatograph, or a carbon dioxide and/or hydrogen sulphide and/or methane and/or ethane removal unit. The air or gas treatment unit is configured to remove at least parts of components from gas received from at least a first aperture 20 and/or from at least a second aperture 30 of the vessel 10, as will be explained below.

According to a preferred embodiment, the vessel 10 is configured to receive compressed gas having a pressure between 1.1 bar absolute and 30 bar absolute, preferably between 2 bar absolute and 16 bar absolute. This is the case for example when gas flows in the axial direction of the vessel 10 from bottom towards the top.

The vessel 10 comprises at least a first aperture 20 and at least a second aperture 30. The first aperture 20 and the second aperture 30 define a passage 40 between them. The passage 40 is configured to allow gas flows between the first and second apertures 20, 30.

The vessel 10 also comprises an adsorbent material or catalyst 50 placed between the first and second apertures 20, 30. The vessel 10 also comprises at least a flexible compressible element 60 arranged in the passage 40.

The vessel 10 is typically used in a pressure swing adsorption process. A co-current flow typically enters the vessel 10 by the first aperture 20 and leaves the vessel via the second aperture 30. In this case, the at least a first aperture 20 is configured to receive gas with an incoming gaseous composition, and the at least a second aperture 30 is configured to release gas having an outgoing gaseous composition. A counter current flow typically enters the vessel 10 via the second aperture 30 and leaves the vessel 10 via the first aperture 20. In this case, the at least a second aperture 30 is configured to receive gas with an incoming gaseous composition, and the at least a first aperture 20 is configured to release gas having an outgoing gaseous composition. The first aperture 20 is for example located at the bottom of the vessel 10. The second aperture 30 is for example located on the top of the vessel 10.

In the description that follows, unless indicated otherwise, the first aperture 20 corresponds to the inlet of a co-current flow into the vessel 10. The vessel 10 has a co-current flow when it operates in the adsorption mode. The second aperture 30 corresponds to the outlet of a co-current flow out of the vessel 10. Consequently, the first aperture 20 is the outlet of a counter current flow out of the vessel 10. The vessels 10 has a counter current flow when it operates in the desorption mode. The second aperture 30 corresponds then to the inlet of a counter current flow into the vessel 10.

According to some embodiments such as those shown in FIGS. 1-5 the first aperture 20 comprises a first mesh 150. In addition or as an alternative, a second aperture 30 comprises a second mesh 160. The first mesh 150 and/or the second mesh 160 can have a U.S. Mesh size ranging from 20 to 50.

According to one embodiment the passage 40 is a vertical passage, preferably a substantially cylindrical passage. According to one embodiment the passage 40 has an inner diameter between 49 mm and 3000 mm, preferably between 50 mm and 2000 mm. According to one embodiment the passage 40 has a diameter between 150 mm and 1600 mm. According to some other embodiments the cross section of the vessel 10 is oval, or square.

The cross section of the vessel 10 is typically strictly greater than the diameter of the first aperture 20 and the diameter of the second aperture 30.

The adsorbent material or catalyst 50 is configured to adsorb or trap at least partially at least one component of gas received by the adsorbent material or catalyst 50 such that gas released from the adsorbent material or catalyst 50 has an outgoing composition different from an incoming composition of the gas received by the adsorbent material or catalyst 50.

According to some embodiments the adsorbent material 50 is configured to adsorb at least one type of gas chosen from the list of: carbon dioxide and/or moisture and/or nitrogen and/or oxygen and/or argon and/or hydrogen and/or hydrogen sulphide and/or mercaptans and/or paraffins, and/or acid gases, and/or silanes, and/or mercury vapour, and/or hydrocarbons, and/or trace contaminants in air or gas (sulphur dioxide, hydrogen chloride, nitrous oxide, ozone, hydrocarbons, volatile organic compounds, NOx, dust, radioactive rare gases, ammonia).

According to some embodiments the adsorbent material 50 includes metal-organic frameworks, and/or carbon materials (such as activated carbon, carbon molecular sieves, carbon fibres), and/or resins, and/or polymers, and/or clays, and/or silica gel, and/or activated alumina, and/or natural or synthetic zeolites (types A, X, Y, mordenite, silicalite, chabazite, faujasite, clinoptilolite, and/or their ion-exchanged varieties: KA, 3A, 4A, 5A, 10A, Si-CHA, ITQ, ZSM, 13X, LiX, CaX, CA-LSX, Li-LSX, NaX, CaA).

According to one embodiment the said adsorbent material or catalyst 50 is an adsorbent configured to adsorb physically at least one component of gas received from the first aperture 20 and/or the second aperture 30. The adsorbent is able to create a physical bond with the at least one component of gas. For example, the adsorbent 50 is configured to adsorb at least partially at least one component of gas passing through the adsorbent 50 such that the gas released from the adsorbent 50 has a composition different from the composition of received gas. According to another embodiment the said adsorbent material or catalyst 50 is a catalyst configured to react chemically at least with one component of gas received from the first aperture 20 and/or the second aperture 30. The catalyst traps at least partially at least one component of gas received by the catalyst 50 such that gas released from the catalyst 50 has an outgoing composition different from an incoming composition of the gas received by the catalyst. The catalyst creates a chemical bond with at least one component of gas. The chemical bond with the catalyst is typically stronger than the physical bond with the adsorbent. More generally, where this description mentions an adsorbent material, a catalyst can replace the adsorbent material there.

According to some embodiments the adsorbent material 50 is in the form of beads, pellets or specific structures like foams, fabric, monoliths, or laminates. For example, the adsorbent material 50 are adsorbent beads having an average diameter lower than 4 mm.

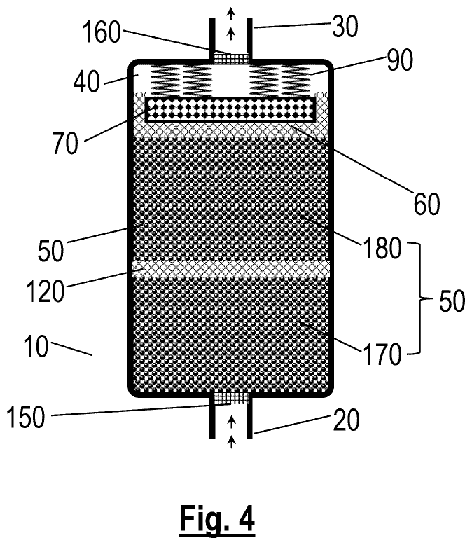

According to the embodiment as shown in FIG. 4-9, the adsorbent material 50 comprises a first portion 170 of the adsorbent material and a second portion 180 of the adsorbent material distinct from the first portion 170 of the adsorbent material. The first portion 170 of the adsorbent material for example differs from the second portion 180 of the adsorbent material in its average diameter, or in its chemical composition (for example, the first portion 170 is configured to adsorb one gaseous component and the second portion 180 is configured to adsorb another gaseous component).

At least a flexible compressible element 60 is configured to fix the adsorbent material 50 in the passage 40.

According to some embodiments such as those shown in the FIGS. 1-9, at least one flexible compressible element comprises a porous compressible element 60, 100. The porous compressible element 60, 100 is arranged between the adsorbent material 50 and the second aperture 30, and/or between the adsorbent material 50 and the first aperture 20.

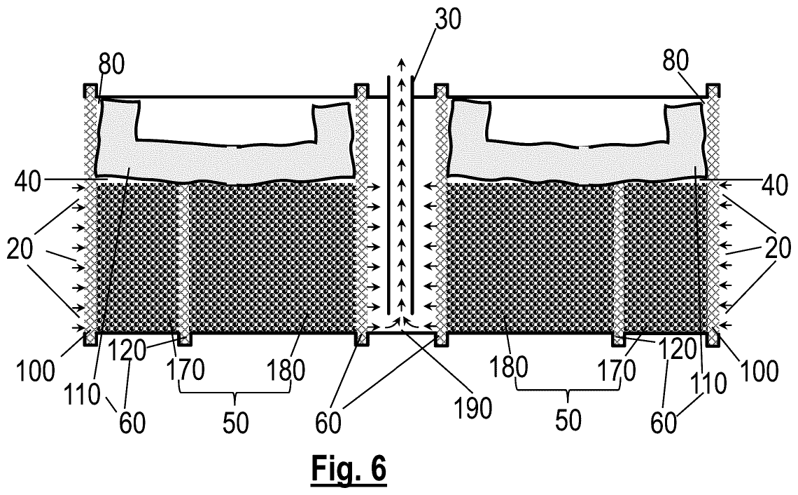

According to some embodiments the vessel 10 is as disclosed in EP 0 820 798 A2 which is incorporated in this application in entirety. According to some embodiments the second apertures 30 of the vessel 10 open up to a central passage 190 of the vessel 10, as can be seen in FIGS. 6-9.

According to some embodiments such as those shown in FIGS. 6-9, at least a flexible compressible element also comprises at least one impermeable compressible element 110. The impermeable compressible element 110 is present typically in a vessel 10 where gas flows in the radial direction, such as those shown in FIGS. 6-9. According to some embodiments the impermeable compressible element 110 is made of the same material as the porous compressible element 60. The impermeable compressible element 110 will be described in more detail below.

At least one of the porous and/or impermeable compressible elements 60, 110 has a higher compressibility than the adsorbent material 50. According to some embodiments the porous compressible element 60 and/or the impermeable compressible element 110 is able to be reduced by at least 25% in volume, preferably by at least 35% in volume, more preferably by at least 50% in volume, even more preferably by at least 85% in volume, even more preferably by at least 90% in volume under a pressure of 0.01 MPa-2 MPa. For example, under a pressure of 0.01 MPa the compressible element 60 is able to be reduced by at least 25% in volume, preferably by at least 35% in volume, more preferably by at least 50% in volume, even more preferably by at least 85% in volume. For example, under a pressure of 2 MPa the compressible element 60 is able to be reduced by at least 25% in volume, preferably by at least 35% in volume, more preferably by at least 50% in volume, even more preferably by at least 85% in volume. The pressure of 0.01 MPa-2 MPa is for example applied in a direction in which the compressible element 60 has the smallest dimension when the compressible element 60 is in an uncompressed state.

According to some embodiments the compressible element 60 has a porosity greater than 80%, preferably greater than 90%, more preferably greater than 95% in an uncompressed state. The porosity of the compressible element 60 was measured via a direct method: first the bulk volume of the porous sample was obtained, and then the volume of the skeletal material without pores was obtained.

According to some embodiments even when its volume is reduced by 85% compared to its uncompressed state the compressible element 60 still has a porosity between 23% and 70%.

When the gas flow in the vessel 10 is in the axial direction, according to some embodiments the porous compressible element 60 occupies the entire cross section of the passage 40 such that gas passes through the porous compressible element 60. Some of these embodiments are depicted in FIGS. 1-5.

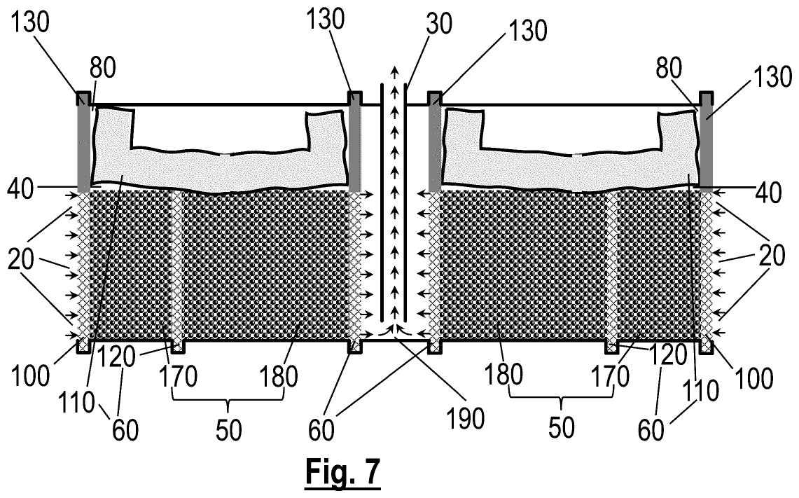

When the gas flow in the vessel 10 is in the radial direction, according to some embodiments the porous compressible element 60 occupies the entire height of the adsorbent material 50 such that, gas passes through the porous compressible element 60. Some of these embodiments are depicted in FIGS. 7-9.

When the gas flow in the vessel 10 is in the radial direction, according to some embodiments such as those showing FIGS. 7-9 the porous compressible elements 100 only occupies a part of the first aperture 20, and the porous compressible element 60 only occupies a part of the second aperture 30. The rest of the first aperture 20 and/or the rest of the second aperture 30 is sealed by an impermeable seal 130. As seen in the FIGS. 7-9, under some embodiments the impermeable seal 130 extends from the upper wall of the vessel 10 to the height level of the top of the adsorbent material 50. In this way the impermeable seal 130 has approximately the same height as that of the impermeable compressible element 110. The height here is measured perpendicularly to the gas flow direction in the radial layout of the vessel 10, also known in the art as the radial beds. This layout helps achieve a plug flow in the radial beds and reduce back mixing. This reduces the chance that gas flows towards the impermeable compressible element 110 and ensures that gas only flows in the adsorbent material.

According to some other embodiments such for that shown in FIG. 6 the porous compressible element 100 covers the entire first aperture 20, and/or the porous compressible element 60 covers the entire second aperture 30.

According to some embodiments the compressible element 60 only occupies part of the cross section of the passage 40.

According to some embodiments the porous compressible element 60 is made of a knitted material, a non-woven material, a woven material, or a foam. The porous compressible element 60 for example comprises a knitted mesh. The knitted mesh for example comprises several layers.

According to some embodiments the compressible element 60 has a flexural modulus higher than 200 MPa, preferably higher than 400 MPa, more preferably higher than 500 MPa. According to some embodiments the compressible element 60 has a tensile strength higher than 10 MPa, preferably higher than 15 MPa, more preferably higher than 20 MPa. By having a high resistance to thermal, and/or chemical, and/or mechanical stress, the compressible elements can have wider applications.

According to some embodiments the porous compressible element 60 and/or the impermeable compressible element 110 is essentially made of perfluoroalkoxy alkane (PFA), or polytetrafluoroethylene (PTFE or e-PTFE), or fluorinated ethylene propylene (FEP).

According to some embodiments the compressible element 60 forms a pad or a cushion.

As depicted in FIGS. 4, 5, and 6-9, when the adsorbent material 50 comprises at least a first portion 170 and a second portion 180, the vessel 10 preferably further comprises an intermediate layer 120 of the porous compressible material 60 sandwiched between the first portion 170 and the second portion 180 of the adsorbent material. According to some embodiments not represented in the figures, instead of having an intermediate layer 120 of the compressible material between the first and second portions 170, 180 of the adsorbent material, the vessel 10 comprises a mesh between the first portion 170 and the second portion 180 of the adsorbent material.

The intermediate layer 120 of the flexible compressible material is for example made of the same material as the flexible compressible element 60. As an alternative, the intermediate layer 120 of the flexible compressible material is made of a different material from that of the flexible compressible element 60.

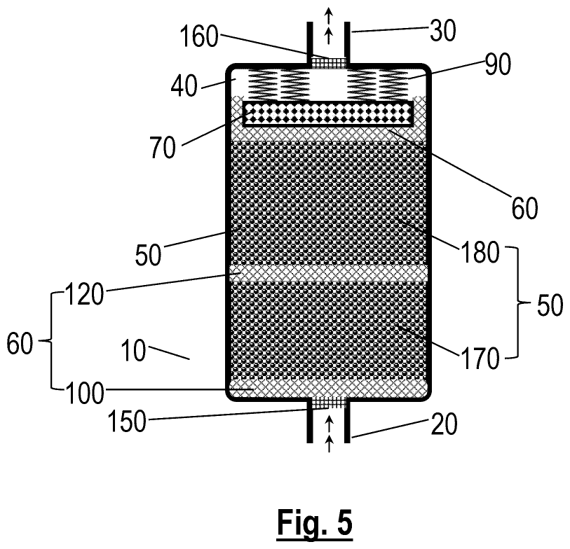

When the gas flow in the vessel 10 is in the axial direction, preferably the intermediate layer 120 of the porous compressible material occupies the entire cross section of the passage 40, as depicted in FIGS. 4 and 5.

When the gas flow in the vessel 10 is in the radial direction, preferably the intermediate layer 120 of the porous compressible material occupies the entire height of the adsorbent material 50, as depicted in FIGS. 6-9.

According to one embodiment, the intermediate layer 120 of the porous compressible material 60 is configured to reduce the mixing of the first portion 170 with the second portion 180 of the adsorbent material. This embodiment is particularly advantageous when the first portion 170 of the adsorbent material is different from the second portion 180 of the adsorbent material.

According to some embodiments the pressure drop across at least one of the compressible elements 60, 100 and 120, is lower than 6 mbar absolute. The compressible element(s) here is typically porous such as the porous flexible compressible elements described in this application.

According to some embodiments the flexibility and/or the compressibility of the porous compressible element 60 and/or of the impermeable compressor element 110 is capable of reducing the crushing of the adsorbent material 50, for example the crushing by the porous compressible element 60 and/or the impermeable compressible element 110.

According to some embodiments the porosity of the compressible element 60, 100 and 120 is capable of re-distributing gas passing through it, for example over the cross section of the passage 40. For example, when a flux of gas enters from the first aperture 20 and/or from the second aperture 30, the compressible element 100 is able to spread the gas over the entire cross section of the passage 40. This is because, the porous compressible element 100 is essentially a matrix of complex channels through which the gas flows. These channels are spread over the entire cross section of the passage 40. This in-turn improves the gas flow distribution over the entire surface of the adsorbent material 50.

According to some embodiments the porous compressible element 100 is configured to form a barrier between the adsorbent material 50 and the first aperture 20 and/or the porous compressible element 60 is configured to form a barrier between the adsorbent material 50 and the second aperture 30 so as to prevent the adsorbent material 50 from escaping the vessel 10.

According to one embodiment at least one of the porous compressible elements 60, 120 or 100 may comprises several layers, for example, several separate cushions laid over one another. The layer of the porous compressible element(s) intended to be in contact with the adsorbent material 50, for example when the adsorbent material 50 comprises adsorbent beads, is finer than the layer of the porous compressible element 60 intended to be near the outlet of the vessel 10. This can reduce the overall cost of the porous compressible element 60 while retaining and/or enhancing its other required capabilities like, resulting in a lower pressure drop, retaining the adsorbent beads inside the vessel 10 and/or avoiding the trapping of adsorbent beads within the matrix of the porous compressible element(s).

According to some embodiments not represented in the figures, the flexible compressible element 60 is also present within the first aperture 20 and/or the second aperture 30.

In addition or as an alternative to the embodiments with at least a porous compressible element 60, the flexible compressible element may comprise at least an impermeable (non-porous) compressible element 110. FIGS. 6-9 show the vessel 10 where an impermeable compressible element 110 is placed above the adsorbent material 50.

According to the embodiments shown in FIGS. 6-9 the vessel 10 comprises a porous compressible element 100 between the first aperture 20 and the adsorbent material 50. The vessel 10 comprises a porous compressible element 60 between the second aperture 30 and the adsorbent material 50. According to the embodiments shown in FIGS. 6-9 the vessel 10 comprises a first portion 170 of the adsorbent material and a second portion 180 of the adsorbent material. The vessel 10 also comprises an intermediate layer 120 of the porous flexible compressible element sandwiched between the first and second portions 170, 180 of the adsorbent material.

According to some embodiments not shown in the figures, the radial bed configuration may only contain the impermeable compressible element 110.

According to some embodiments at least one of the impermeable compressible element(s) 110 has a higher compressibility than the adsorbent material 50. According to some embodiments the impermeable compressible element 110 is able to be reduced by at least 25% in volume, preferably by at least 35% in volume, more preferably by at least 50% in volume, even more preferably by at least 85% in volume, even more preferably by at least 90% in volume under a pressure of 0.01 MPa-2 MPa.

The impermeable compressible element 110 is inert to the components that it is in contact with in an air or gas treatment unit.

The porous flexible compressible element 60, optionally together with the perforated strainer plate 70 and/or the compression elements 90 if present, in a vessel 10 where the gas flow is in the axial direction, such as those shown in FIGS. 1-5, are preferably arranged and configured such that the adsorbent material 50 remains substantially immobilised when gas passes through the adsorbent material 50. Additionally, the impermeable flexible compressible element 110, optionally together with the (perforated or non-perforated) strainer plate 140 and/or the compression elements 90 in a vessel 10 where the gas flow is in the radial direction, such as those shown in FIGS. 6-9, are preferably arranged and configured such that the adsorbent material 50 remains substantially immobilised when gas passes through the adsorbent material 50. For example, in the vessel 10 where the gas flow is in the axial direction, such as those shown in FIGS. 1-5, the porous compressible element 60, optionally together with the perforated strainer plate 70 and/or the compression elements 90 immobilise the adsorbent material 50 by applying a force approximately opposite to the gas flow direction in the passage 40.

In an adsorber and/or a reactor, where the gas flow is in the radial direction such as those shown in FIGS. 6-9, the impermeable compressible element 110, optionally together with the (perforated or non-perforated) strainer plate 140 and/or the compression elements 90 immobilise the adsorbent material 50 by applying a force approximately perpendicular to the gas flow direction. In the embodiments in FIGS. 6-9 the gas flow is in the horizontal direction between the first and the second apertures 20, 30 while the immobilising force is exerted in the vertical direction.

According to some embodiments at least one of the porous or impermeable compressible elements 60, 100, 110, 120 has a melting temperature higher than 250° C., preferably higher than 300° C., more preferably higher than 320° C.

According to some embodiments at least one of the porous or impermeable compressible elements 60, 100, 110, 120 has an ignition temperature higher than 165° C., preferably higher than 200° C., more preferably higher than 300° C., even more preferably higher than 400° C., even more preferably higher than 500° C.

According to some embodiments at least one of the porous or impermeable compressible elements 60, 100, 110, 120 is incombustible in a 60° C. environment having 95% oxygen and a pressure of 10 bar absolute.

According to some embodiments at least one of the porous compressible elements 60, 100, 120 maintains its structural integrity when gas at the pressure of 0.1 to 10 bar absolute flows through it. In particular, at least one of the compressible elements 60, 100, 120 does not tear when gas at the pressure of 0.1 to 10 bar absolute passes through it.

According to some embodiment at least one of the porous or impermeable compressible elements 60, 100, 110, 120 maintains their structural integrity when the pressure in the vessel 10 is within the range of 0.1 to 10 bar absolute. In particular, at least one of the porous or impermeable compressible elements 60, 100, 110, 120 does not tear when the pressure in the vessel 10 is within the range of 0.1 to 10 bar absolute.

According to some embodiments at least the peripheral portion of at least one of the compressible elements 60, 100, 110, 120 does not contain any metallic component, preferably at least one of the compressible elements 60, 100, 110, 120 does not contain any metallic component (in their entirety). Since at least one of the porous or impermeable compressible elements 60, 100, 110, 120 is in contact with the wall of the vessel 10 which is often made of a metal, a compressible element 60, 100, 110, 120 without any metallic component can reduce the chance of generating sparks when they rub against the inner walls of the vessel 10.

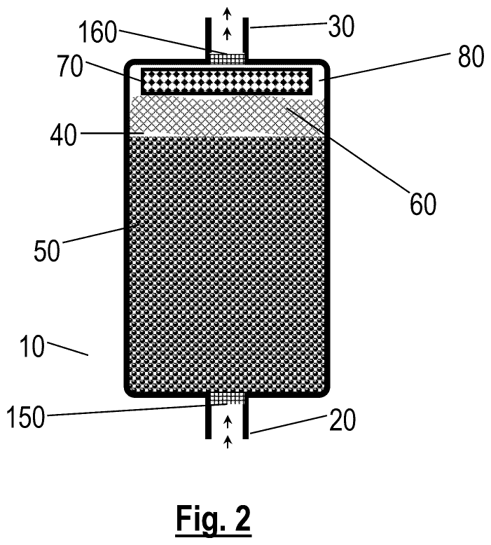

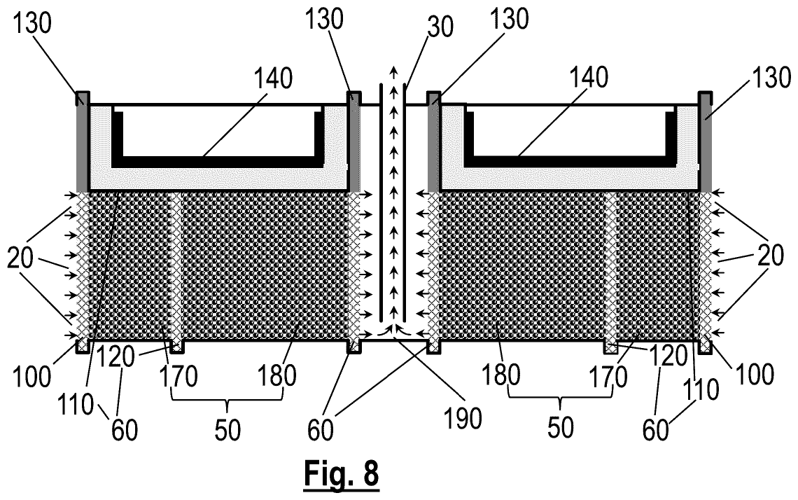

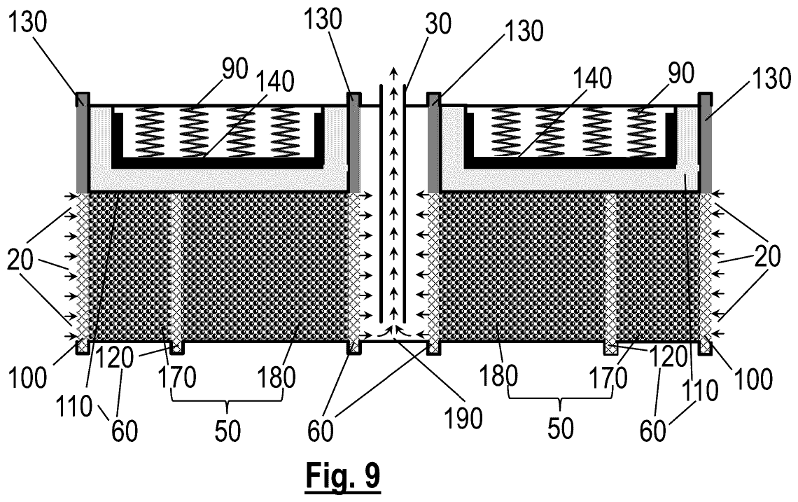

According to some embodiments, the vessel 10 further comprises a plate 70, as depicted in FIGS. 2-5 or a plate 140, as depicted in FIGS. 8 and 9. These plates can be a metallic or non-metallic. According to some embodiments, where gas flows in the vessel 10 in the axial direction such as those shown in FIGS. 2-5, the plate 70 is perforated, such as a perforated strainer. The perforated strainer is for example located between the porous compressible element 60 and the second aperture 30. According to some embodiments where the gas flows in the vessel 10 in the radial direction such as those shown in FIGS. 8 and 9, the plate 140 can be solid or perforated strainer plate. According to some embodiments the plate 140 is located between the impermeable compressible element 110, the upper wall of the vessel 10 and/or, compression elements 90.

According to some embodiments the plate 70 and 140 have a shape complementary to that of their corresponding flexible compressible elements 60 and 110, respectively. This is particularly visible in FIGS. 8 and 9.

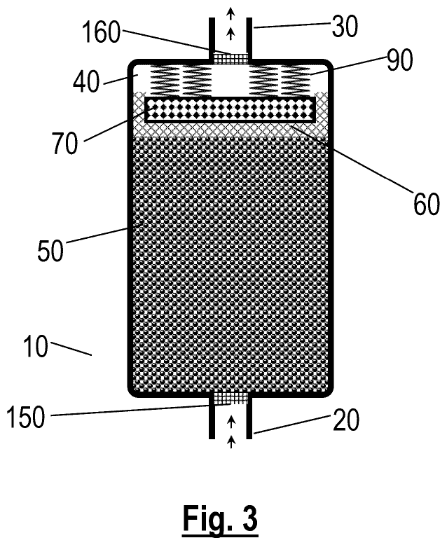

According to some embodiments such as those shown in FIGS. 3-5 and 9, the vessel 10 further comprises at least one compression element 90, such as one or more springs, configured for pressing the strainer plate 70, 140 against the flexible compressible element 60, 110. The flexible compressible element 60, 110 presses against the adsorbent material 50. The plate 70, 140 helps evenly flatten the porous and/or impermeable flexible compressible element 60, 110. The plate 70 also helps in near-uniform distribution of the force exerted by the compression element(s) 90 over the entire cross-section of the flexible compressible element 60, 110 and thereby, the adsorbent material 50.

According to some embodiments, such as those shown in FIGS. 3-5, the compression element 90 is located between the plate 70 and the second aperture 30. According to some embodiments, such as that in FIG. 9, the compression element 90 is located between the plate 140 and an upper wall of the vessel 10.

Where the gas flows in the axial direction, preferably the plate 70 comprises a fine mesh sandwiched between two preferably identical perforated strainer plates. Such an arrangement can reduce or eliminate the escape of the adsorbent material 50 via the perforated strainer plate. It will also allow for unform distribution of gas over the entire cross section of the adsorbent material 50, as gas tends to go through all the holes of the fine mesh and/or the perforated strainer plates. Depending on the required strength, the thickness of each of such perforated strainer plate can be preferably between 1 mm to 20 mm. The holes in each of such perforated strainer plate can be preferably of a diameter ranging between 20 mm to 100 mm. The fine mesh sandwiched between two of such perforated strainer plates can have a U.S. Mesh size ranging from 20 to 50.

Depending on the required strength, the thickness of the solid strainer plate 140 can be preferably between 1 mm to 20 mm.

According to some embodiments visible in FIGS. 2-5, the perforated plate 70 has a diameter smaller than the diameter of the passage 40. According to some embodiments visible in FIGS. 8 and 9, the plate 140 has a size smaller than that of the vessel 10 seen from above the vessel 10. The plate 70 avoids direct contact with the inner wall of the vessel 10, thereby reducing or eliminating the risk of the plate rubbing against the inner wall of the vessel 10 and potentially generating sparks. In this way the plate and the inner wall of the vessel 10 define a gap 80 between them. According to some embodiments at least one of the porous compressible element 60 and the impermeable compressible element 110 is configured to fill the gap 80 so as to prevent the adsorbent material 50 from escaping the vessel 10 through the gap 80. Such an arrangement also reduces or eliminates the risk of the plate rubbing against the inner wall of the vessel 10.

According to one embodiment the plate 70 is in direct contact with the porous flexible compressible element 60. According to one embodiment the plate 140 is in direct contact with the impermeable flexible compressible element 110.

According to some embodiments at least one of the flexible compressible elements 60, 100, 110, 120 is made of a material inert to the components that it is exposed to in the vessel 10. For example, at least one of the flexible compressible elements 60, 100, 110, 120 is inert to an incoming gas received from the at least a first aperture 20 or from the at least a second aperture 30, and/or an outgoing gas released from the at least a second aperture 30 or from the at least a first aperture 20, and/or a material inert to the material of the vessel 10, and/or a material inert to the adsorbent material 50, and/or a material inert to the material of the perforated plate 70 and/or of the solid plate 140.

According to some embodiments such as shown on FIGS. 5-9, in addition to the compressible element 60 between the adsorbent material 50 and the second aperture 30, the vessel 10 further comprises an additional flexible compressible element 100 between the adsorbent material 50 and the first aperture 20. The additional compressible element 100 is porous. In one embodiment the additional flexible compressible element 100 is made of the same material as that of the porous compressible element 60. According to another embodiment the additional flexible compressible element 100 is made of a material different from that of the flexible porous compressible element 60. In the embodiment shown in FIG. 5, for a vessel in which the gas flow is in the axial direction, the compressible element 60 between the adsorbent material 50 and the outlet of the vessel 10 when the vessel receives a co-current flow (shown as the second aperture 30 above the first aperture 20) is essential for the embodiment. The additional compressible element 100 between the adsorbent material 50 and the inlet of the vessel when the vessel receives a co-current flow (shown as the first aperture 20 below the second aperture 30) is optional for this embodiment.

In the embodiment shown in FIGS. 6-9, for a vessel in which the gas flow is in the radial direction, preferably the vessel 10 comprises a porous compressible element 100 between the adsorbent material 50 and the first aperture 20, and/or the vessel 10 comprises a porous compressible element 60 between the adsorbent material 50 and the second aperture 30.

According to some embodiments the additional compressible element 100 is configured to minimise, preferentially to eliminate, the escape of the adsorbent material 50 from the first aperture 20.

According to some embodiments the gas treatment unit is a dryer instead of an oxygen or nitrogen generator. In these embodiments, the adsorbent material 50 is a desiccant configured to adsorb at least partially moisture in the gas flowing through the vessel 10.

The present disclosure also relates to a method for using a vessel 10 as disclosed above. During the adsorption step of the process, feed gas is received from the at least a first aperture 20. Typically, the pressure of such received gas is higher than 1 bar absolute and the flow of such gas is from the first aperture 20 to the second aperture 30. At least one of the components of the received gas is at least partially adsorbed by the adsorbent material 50 or trapped by the catalyst 50. So, the gas released through the second aperture 30 is lean in terms of the components that were adsorbed. Desorption is the step (not depicted) when at least one of the adsorbed components is at least partially removed from the adsorbent material 50. During the desorption step of the process, recycle gas is fed at the second aperture 30 and exhaust gas is evacuated via the first aperture 20. Typically, the pressure of such exhaust gas is lower than the feed gas pressure and it is evacuated out of the adsorption system via the first aperture 20. Depending on the process application, the pressure at the first aperture 20 can reach as high as 30 bar absolute during the adsorption step. On the other hand, the pressure at the first aperture 20 can reach as low as 0.1 bar absolute during the desorption step.

When compressed feed gas flows inside the passage 40 and reaches the adsorbent material 50 or the catalyst, the adsorbent material 50 adsorbs or the catalyst traps at least partially at least one component of gas received by the adsorbent material 50 or the catalyst. At the same time, the porous flexible compressible element 60 presses against the adsorbent material 50 or catalyst in axial beds (FIGS. 1-5) and the impermeable compressible element 110 presses against the adsorbent material 50 or the catalyst in radial beds (FIGS. 6-9). If the compressible element comprises the porous compressible element(s) 60, the gas passes through the porous compressible element(s) 60.

Preferably the adsorbent material 50 remains substantially immobilised when gas passes through it.

Because of the adsorption by the adsorbent material 50 or the trapping by the catalyst, gas released from the adsorbent material 50 or catalyst has an outgoing composition different from an incoming composition of the gas received by the adsorbent material 50 or catalyst.

Gas received by the at least a first aperture 20 or the at least a second aperture 30, and/or gas released from the at least a second aperture 30 or the at least a first aperture 20 has a flux between 0.1 Nm³/h-16000 Nm³/h, preferably between 2 Nm³/h-1000 Nm³/h, more preferably between 2 Nm³/h-30 Nm³/h.

1-35. (canceled)

36. A vessel for an adsorber or reactor, comprising:
at least a first aperture configured to receive and to release gas and at least a second aperture configured to release and to receive gas, the first and the second apertures defining a passage between them;
an adsorbent material or catalyst placed between the first and the second apertures, the adsorbent material or catalyst being configured to adsorb or trap at least partially at least one component of gas received by the adsorbent material or catalyst such that gas released from the adsorbent material or catalyst has an outgoing composition different from an incoming composition of the gas received by the adsorbent material or catalyst;
at least a flexible compressible element arranged in said passage configured to fix the adsorbent material or catalyst in said passage, the flexible compressible element having a higher compressibility than the adsorbent material or catalyst,
wherein the passage has a diameter between 49 mm and 3000 mm.

37. The vessel according to claim 36, wherein the flexible compressible element is porous and is arranged between the adsorbent material or catalyst and the second aperture, and/or between the adsorbent material or catalyst and the first aperture.

38. The vessel according to claim 36, wherein at least one of the flexible compressible element is able to be reduced by at least 25% in volume under a pressure of 0.01 MPa-2 MPa.

39. The vessel according to claim 36, wherein at least one of the flexible compressible element has a porosity greater than 80% in an uncompressed state.

40. The vessel according to claim 36, wherein at least one of the flexible compressible element has a porosity between 23% and 70% when its volume is reduced by 85% compared to an uncompressed state.

41. The vessel according to claim 36, wherein at least one of the flexible compressible element occupies an entire cross section of the passage such that gas passes through the compressible element(s).

42. The vessel according to claim 36, wherein at least one of the flexible compressible element has a melting temperature higher than 250° C.

43. The vessel according to claim 36, wherein the flexible compressible element is configured to form a barrier between the adsorbent material or catalyst and the second aperture and/or the flexible compressible element is configured to form a barrier between the adsorbent material or catalyst and the first aperture so as to prevent the adsorbent material or catalyst from escaping the vessel.

44. The vessel according to claim 36, wherein at least one of the flexible compressible element is made of a knitted material, a non-woven material, a woven material, or a foam, or wherein the at least one of the flexible compressible element forms a pad or a cushion.

45. The vessel according to claim 36, wherein the adsorbent material or catalyst comprises a first portion and a second portion, the vessel further comprising an intermediate layer of the flexible compressible material sandwiched between the first portion and the second portion of the adsorbent material or catalyst, and/or wherein the intermediate layer of the flexible compressible material is configured to reduce the mixing of the first portion with the second portion of the adsorbent material or catalyst.

46. The vessel according to claim 36, further comprising at least a plate configured for pressing the compressible element against the adsorbent material or catalyst, the plate being perforated, and/or further comprising one or more compression elements, the plate being located between the compression element(s) and the compressible element such that the compression element pushes the plate towards the compressible element.

47. The vessel according to claim 36, wherein the plate and the vessel define at least a gap between them, the compressible element being configured to fill the gap so as to prevent the adsorbent material or catalyst from escaping the vessel.

48. The vessel according to claim 36, further comprising a first mesh in the first aperture, and/or a second mesh in the second aperture.

49. The vessel according to claim 36, wherein the flexibility and/or the compressibility of the compressible element is capable of reducing the crushing of the adsorbent material or catalyst.

50. The vessel according to claim 36, wherein the flexible compressible element is configured such that the pressure drop across the flexible compressible element is lower than 6 mbar absolute.

51. The vessel according to claim 36, wherein the compressible element is arranged and configured such that the adsorbent material or catalyst remains substantially immobilised when gas passes through it.

52. The vessel according to claim 36, wherein at least one of the flexible compressible element is impermeable to gas contained within the vessel, and/or wherein at least one of the first aperture and the second aperture is sealed from an upper wall of the vessel to the top level of the adsorbent material or catalyst.

53. The vessel according to claim 36, wherein the compressible element is incombustible in a 60° C. environment having 95% oxygen and a pressure of 10 bar absolute, and/or
wherein the compressible element is made of a material inert to one or more of the following:
an incoming or outcoming gas received from the at least a first aperture or from the at least a second aperture,
a material inert to the material of the vessel,
a material inert to the adsorbent material or catalyst,
a material inert to the material of the plate,
a material inert to the material of the compression element(s).

54. The vessel according to claim 36, wherein the flexible compressible element is essentially made of perfluoroalkoxy alkane (PFA), or polytetrafluoroethylene (PTFE or e-PTFE), or fluorinated ethylene propylene (FEP).

55. The vessel according to claim 36, wherein the adsorbent material or catalyst includes metal-organic frameworks, and/or carbon materials, and/or resins, and/or polymers, and/or clays, and/or silica gel, and/or activated alumina, and/or natural or synthetic zeolites.

56. An air or gas treatment unit, or an air or gas dryer, or a desulfurization unit, or a solvent vapour recovery unit, or a silanes removal unit, or a trace radioactive rare gases removal unit, or a mercury vapour trapping unit, or a deodorizing and air freshening unit, or a trace ammonia removal unit, or a hydrogen production unit, or a gas separator, or an alcohol dehydrator, or a gas chromatograph, or a carbon dioxide and/or hydrogen sulphide and/or methane and/or ethane removal unit configured to remove at least parts of components from gas received from a at least a first aperture and/or from a at least a second aperture, comprising at least one vessel according to claim 36, the vessel being configured to receive compressed gas having a pressure between 1.1 bar absolute and 30 bar absolute.

57. A method for using a vessel according to claim 36, comprising the steps of:
receiving gas from the at least a first aperture or, respectively, from the at least a second aperture,
the adsorbent material or catalyst adsorbing or trapping at least partially at least one component of gas received by the adsorbent material or catalyst, wherein the flexible compressible element(s) presses against the adsorbent material or catalyst, released gas from the adsorbent material or catalyst having an outgoing composition different from an incoming composition of the gas received by the adsorbent material or catalyst,
releasing gas from the at least a second aperture or, respectively, from the at least a first aperture.
